(19) United States
(12) Patent Application Publication
(10) Pub. No.: US 2014/0255776 A1
(43) Pub. Date: Sep. 11, 2014

(54) METHOD FOR MANUFACTURING ELECTRODE, ELECTRODE MANUFACTURED ACCORDING TO THE METHOD, SUPERCAPACITOR INCLUDING THE ELECTRODE, AND RECHARGABLE LITHIUM BATTERY INCLUDING THE ELECTRODE

(71) Applicant: Korea Institute Of Science and Technology, (US)

(72) Inventors: Yong-Won SONG, Daejeon (KR); Jung Ah LIM, Gyeonggi-do (KR); Tae Hee YOO, Gyeonggi-do (KR); Sun Min KIM, Seoul (KR)

(73) Assignee: KOREA INSTITUTE OF SCIENCE AND TECHNOLOGY, Seoul (KR)

(21) Appl. No.: 13/861,067

(22) Filed: Apr. 11, 2013

(30) Foreign Application Priority Data
Mar. 8, 2013 (KR) 10-2013-0025102

(51) Int. Cl. H01G 11/32; H01G 11/48; H01M 4/133; H01M 4/131; H01M 4/1391; H01M 4/1393; H01G 11/46; H01M 4/04

(52) U.S. Cl. CPC H01G 11/32; H01G 11/46; H01G 11/48; H01M 4/0404; H01M 4/131; H01M 4/1391; H01M 4/1393; H01M 4/133
USPC 429/211; 361/502; 427/508

(57) ABSTRACT

Disclosed are a method for manufacturing an electrode including mixing at least two electrode materials selected from a carbon material, a metal oxide precursor, and a conductive polymer with a solvent to prepare a mixture, coating the mixture on a current collector, and radiating IPL (intense pulsed light) on the mixture coated on the current collector, the electrode manufactured according to the method, and a supercapacitor and rechargeable lithium battery including the electrode.

### CROSS-REFERENCE TO RELATED APPLICATION

This application claims priority to and the benefit of Korean Patent Application No. 10-2013-0025102 filed in the Korean Intellectual Property Office on Mar. 8, 2013, the entire contents of which are incorporated herein by reference.

### BACKGROUND OF THE INVENTION

(a) Field of the Invention

A method for manufacturing an electrode, an electrode manufactured according to the method, and a supercapacitor and a rechargeable lithium battery including the electrode are disclosed.

(b) Description of the Related Art

Recently, research on an energy storage system such as a rechargeable lithium battery, a capacitor, and the like has been actively made due to highly increasing interest in environment and energy issues. In particular, a supercapacitor and a rechargeable lithium battery applicable to a field requiring high-capacity and high power characteristics have drawn the most attention.

A capacitor is a device storing electrostatic capacity generated by applying a voltage between two electrodes in an electrolyte. A supercapacitor has higher electrostatic capacity than a common capacitor, and is also called an ultracapacitor.

The supercapacitor is classified into an electric double layer capacitor, a pseudo capacitor, and a hybrid capacitor depending on a material used for an electrode. The electric double layer capacitor uses an electric double charge layer, and the pseudo capacitor increases electrostatic capacity through an oxidation reduction reaction. The hybrid capacitor is made by mixing the electric double layer and the pseudo capacitor.

The supercapacitor stores energy by using an electrochemical mechanism when electrolyte ions are adsorbed on the surface of an electrode. Accordingly, the supercapacitor produces high output and maintains initial performance despite tens of thousands of charges and discharges.

These energy storage systems use various materials such as a carbon material, a metal oxide, a conductive polymer, and the like for an electrode material. In particular, research on applying a composite electrode material prepared by mixing two or more materials selected from the electrode materials to an electrode has been actively made.

The composite electrode material may be prepared in an electrodeposition method, a thermochemical method, a sol-gel method, and the like. However, these methods use a high pressure and thus may be dangerous, and also need an annealing process and thus may require a lot of time. The sol-gel method may be simple but produces non-uniform particles. Accordingly, development of a simple method of manufacturing an electrode material having excellent particle uniformity is required.

### SUMMARY OF THE INVENTION

One exemplary embodiment of the present invention provides a method for manufacturing an electrode that is simple and able to be performed in a short term, and a supercapacitor and a rechargeable lithium battery including the electrode and having excellent electrostatic capacity, cycle-life characteristic, and stability.

In one embodiment of the present invention, a method for manufacturing an electrode includes mixing at least two electrode materials selected from a carbon material, a metal oxide precursor, and a conductive polymer with a solvent to prepare a mixture, coating the mixture on a current collector, and radiating IPL (intense pulsed light) on the mixture coated on the current collector.

The carbon material may be activated carbon, graphite, graphene, graphene oxide, carbon nanotubes, or a combination thereof.

When the carbon material is the graphene oxide, the graphene oxide may be reduced by radiating the IPL.

The metal oxide precursor may include copper, nickel, ruthenium, manganese, molybdenum, vanadium, aluminum silver, iridium, iron, cobalt, chromium, tungsten, titanium, palladium, or a combination thereof.

The conductive polymer may include a polyaniline-based polymer, a polythiophene-based polymer, a polypyrrole-based polymer, a polyacetylene-based polymer, a polyparaphenylene-based polymer, or a combination thereof.

The electrode material may be a carbon material and a metal oxide precursor.

The carbon material and the metal oxide precursor may be mixed in a weight ratio of 1:0.1 to 1:10.

The electrode material may be a carbon material and a conductive polymer.

The electrode material may be a metal oxide precursor and a conductive polymer.

The method for manufacturing an electrode may further include removal of a solvent after coating the mixture on a current collector.

The IPL radiation may be performed at room temperature.

The IPL radiation may be performed under an air atmosphere.

The IPL may have a pulse on-time ranging from 0.1 to 500 ms, a pulse off-time ranging from 0.1 to 500 ms, a number of pulses ranging from 1 to 99, or pulse energy ranging from 0.1 to 200 J/cm².

In another embodiment of the present invention, an electrode manufactured according to the manufacturing method includes at least two kinds of electrode materials selected from a carbon material, a metal oxide precursor, and a conductive polymer that are uniformly dispersed on a current collector.

In another embodiment of the present invention, a supercapacitor including the electrode, an electrolyte, and a separator is provided.

In another embodiment of the present invention, a rechargeable lithium battery including the electrode, an electrolyte, and a separator is provided.

The method for manufacturing an electrode according to the present invention is simple and may be able to be performed in a short time. The electrode manufactured according to the method may include an electrode material in which particles are uniformly dispersed, but various materials may be applied thereto. In addition, the electrode may realize a supercapacitor and a rechargeable lithium battery having excellent electrostatic capacity, cycle-life characteristic, and stability.

### BRIEF DESCRIPTION OF THE DRAWINGS

FIG. 1 is a schematic view showing a method of manufacturing an electrode according to one embodiment of the present invention.

FIG. 2 is a scanning electron microscope (SEM) photograph showing one electrode according to one embodiment.

FIG. 3 shows an X-ray diffraction pattern of the electrode according to one embodiment.

FIGS. 4 and 5 show circulating current curves of the electrode according to one embodiment.

### DETAILED DESCRIPTION OF THE EMBODIMENTS

Exemplary embodiments will hereinafter be described in the detailed description. However, these embodiments are exemplary, and this disclosure is not limited thereto.

In one embodiment of the present invention, provided is a mixing method for an electrode including at least two electrode materials selected from a carbon material, a metal oxide precursor, and a conductive polymer, with a solvent to prepare a mixture, coating the mixture on a current collector, and radiating IPL on the mixture coated on the current collector.

The method for an electrode may be simple and able to be performed in a short time. In addition, an electrode manufactured according to the method may include an electrode material in which particles are uniformly distributed, and may be applied to a supercapacitor, a rechargeable lithium battery, a flexible device, and the like.

The IPL (intense pulsed light) may be a white single pulse having various wavelengths and being emitted as an intense pulse.

Hereinafter, each component included in the method for an electrode is illustrated in detail.

Carbon Material

The carbon material is an electrode material including carbon, and may form an electric double layer and simultaneously increase electrical conductivity.

Specifically, the carbon material may be activated carbon, graphite, graphene, graphene oxide, carbon nanotubes, soft carbon (carbon fired at a low temperature), hard carbon, a mesophase pitch carbonized product, fired coke, carbon black, acetylene black, ketjen black, carbon fiber, or a combination thereof. More specifically, the carbon material may be graphene, graphene oxide, or carbon nanotubes.

The graphene consists of polycyclic aromatic molecules formed of a plurality of carbon atoms connected through a covalent bond. The graphene has a honeycomb-shaped carbon lattice, in which the carbon atoms connected through a covalent bond form a 6-membered ring as a basic repeating unit, but it may alternatively include a 5-membered ring or a 7-membered ring. In addition, the graphene may form an sp² hybrid carbon sheet monolayer and thus have a thickness of about one atom. However, the graphene may form multiple layers in which less than about 10 carbon sheets are stacked.

The graphene has high transparency and maintains its characteristics even when bent or elongated. In addition, the graphene has high electrical conductivity and mechanical strength, and may be appropriately applied to a flexible device. The graphene has higher electrical conductivity and a larger surface area than carbon nanotubes, and is less expensive. Accordingly, the graphene may be appropriately used as an electrode material for a capacitor or a battery.

The graphene oxide is a compound obtained by oxidizing graphene and having a functional group including oxygen such as an epoxy group, a hydroxy group, a carbonyl group, or a carboxyl group on the surface of the graphene.

The graphene oxide has both of hydrophilic and hydrophobic groups, and thus is amphipathic. In other words, the graphene oxide has hydrophilicity because of an alcohol group, a carboxyl group, and the like, but simultaneously has hydrophobicity because of a basal plane.

The graphene oxide may be a common one used in an art related to the present invention, and has no particular limit in its structure, properties, and the like. Herein, the graphene oxide may be a commercially available one or may be obtained by oxidizing graphite.

The graphene oxide has a functional group including oxygen, and may be mixed with another electrode material and thus is easily prepared into a composite. However, since the graphene oxide insufficient conductivity, conductivity of the graphene oxide may be increased through reduction so it may be used as an electrode material. In general, the reduction of graphene oxide may include chemical reduction using hydrizine monohydrate, a reduction through annealing at a temperature ranging from 700 to 1200° C., and reduction through electrochemically removing an oxygen functional group.

In the present invention, when the graphene oxide is used as the carbon material, the graphene oxide may be reduced by IPL radiation. In other words, the present invention needs no reduction process of the graphene oxide and provides a simple manufacturing method.

On the other hand, the carbon nanotubes are a material wherein hexagons consisting of 6 carbons are connected to one another to form a crown shape, and have excellent thermal conductivity and strength.

The graphite may be natural graphite or artificial graphite, and may be shapeless, sheet-shaped, flake-shaped, spherical-shaped, or fiber-shaped graphite.

The carbon material may have no limit in its size. For example, the carbon material may have an average particle diameter ranging from 1 to 1000 nm, and specifically, 1 to 800 nm, 1 to 600 nm, 100 to 1000 nm, 100 to 800 nm, or 100 to 600 nm.

Metal Oxide Precursor

In the metal oxide precursor, the metal may include copper, nickel, ruthenium, manganese, molybdenum, vanadium, aluminum, silver, iridium, iron, cobalt, chromium, tungsten, titanium, palladium, or a combination thereof. Specifically, the metal may be nickel, ruthenium, manganese, iron, or a combination thereof.

The metal oxide precursor may be in a form of a metal alkoxide, a metal halogen compound, a metal sulfur oxide, a metal nitrogen oxide, a metal acetate, or combination thereof.

The metal oxide precursor may be converted into a metal oxide through IPL radiation. The metal oxide may have an oxidation/reduction reaction in an electrode. The metal oxide may have the oxidation/reduction reaction with ions in an electrolyte, when the ions are intercalated and deinteralated or when the ions are adsorbed on the surface of the metal oxide.

The metal oxide may include, for example, nickel oxide, ruthenium oxide, manganese oxide, and iron oxide, or an oxide of at least two selected from nickel, ruthenium, manganese, and iron.

The ruthenium oxide may have a reaction represented by the following Reaction Scheme 1 in an acidic electrolyte.

RuO₂+xH⁺+xe⁻ [symbol] RuO₂₋ₓ(OH)ₓ [Reaction Scheme 1]

The manganese oxide may cause a reaction represented by the following Reaction Scheme 2 in an alkali electrolyte.

MnO₂+xC⁺+yH⁺+(x+y)e⁻ [symbol] MnOOCₓH_{y} [Reaction Scheme 2]

The ruthenium oxide may realize high electrostatic capacity of greater than or equal to 600 F/g. The manganese oxide is not expensive and is environmentally-friendly.

The metal oxide may be used without a limit in size. For example, the metal oxide may have an average particle diameter ranging from 10 nm to 100 μm.

Conductive Polymer

The conductive polymer is a polymer having electrical conductivity and in general includes a Π bond. The conductive polymer may be, for example, a polyaniline-based polymer, a polythiophene-based polymer, a polypyrrole-based heterocyclic polymer, a polyacetylene-based polymer, a polyparaphenylene-based polymer, or a combination thereof.

Specifically, the conductive polymer may be polyaniline, poly(3,4-ethylenedioxythiophene) (PEDOT), polypyrrole, or a combination thereof.

The polyaniline-based polymer may realize electrostatic capacity ranging from 150 to 190 F/g, and a polypyrrole-based polymer may realize electrostatic capacity ranging from 80 to 100 F/g.

Solvent

The solvent indicates a solvent commonly used in an art related to the present invention. Specifically, the solvent may be an aqueous or organic solvent. In other words, the solvent may be water, an alcohol-based solvent, an amide-based solvent, a carbonate-based solvent, an aromatic hydrocarbon-based solvent, or a combination thereof. For example, the solvent may be water, methanol, ethanol, dimethylformamide (DMF), or a combination thereof.

Current Collector

The current collector may include any material having conductivity without a particular limit, and may include, for example, stainless steel, platinum, gold, copper, carbon series, ITO (In doped SnO₂), FTO (F doped SnO₂), and the like.

Hereinafter, a method of manufacturing the electrode is illustrated in detail.

The method for an electrode includes mixing at least two electrode materials selected from a carbon material, a metal oxide precursor, and a conductive polymer with a solvent to prepare a mixture.

The electrode material may be a carbon material and a metal oxide precursor. The manufacturing method may provide an electrode including the carbon material and a metal oxide uniformly dispersed on a current collector.

The carbon material and the metal oxide precursor may be mixed in an appropriate ratio depending on use and purpose. For example, the carbon material and metal oxide precursor may be mixed in a weight ratio of 1:0.1 to 1:10. Specifically, the carbon material and metal oxide precursor may be mixed in a weight ratio of 1:0.1 to 1:1, 1:0.5 to 1:1, 1:1 to 1:9, 1:1 to 1:8, 1:1 to 1:7, 1:1 to 1:6, and 1:1 to 1:5. When the carbon material and metal oxide precursor are mixed within the ratio, an electrode and a device including the electrode may realize excellent electrostatic capacity, cycle-life characteristic, and stability.

On the other hand, the electrode material may be a carbon material and a conductive polymer. Herein, the manufacturing method may provide an electrode wherein the carbon material and the conductive polymer are uniformly dispersed on a current collector. The carbon material and the conductive polymer may be mixed in an appropriate ratio depending on use and purpose, and specifically, in a weight ratio ranging from 1:10 to 10:1.

The method for an electrode may further include coating the mixture on a current collector after mixing the electrode material with a solvent. In addition, the method may further include removing the solvent after coating the mixture on a current collector. When the solvent is removed, the electrode material may be formed into a thin film on a current collector.

The method for an electrode may further include radiating IPL on the mixture coated on the current collector after coating the mixture on a current collector. The IPL radiation may provide a convenient method of manufacturing an electrode wherein electrode materials are uniformly dispersed on a current collector in a short time.

The IPL radiation may be performed at room temperature. The room temperature may be, for example, in a range of 10° C. to 40° C. The method of manufacturing an electrode using a composite electrode material may be performed at room temperature, unlike a conventional method such as electrodeposition, a thermochemical method, a sol-gel method, and the like requiring a high temperature.

In addition, the IPL radiation may be performed under an air atmosphere. While the conventional manufacturing method may need to be performed under a vacuum or high pressure condition, the method for an electrode according to the present invention may be performed under an air atmosphere.

The electrode may have various characteristics by adjusting on-time and off-time of a pulse, the number of pulses, energy, voltage, and the like during the IPL radiation.

For example, the IPL may have pulse on-time ranging from 0.1 to 500 ms.

The IPL may have pulse off-time ranging from 0.1 to 500 ms.

The IPL may have 1 to 99 pulses.

The IPL may have pulse energy ranging from 0.1 to 200 J/cm².

According to another embodiment of the present invention, an electrode manufactured according to the aforementioned method is provided. The electrode is included in an electrochemical device such as a capacitor, a battery, or the like.

The electrode may include at least two kinds of electrode material selected from a carbon material, a metal oxide precursor, and a conductive polymer that are uniformly dispersed on a current collector.

The electrode has excellent electrical conductivity and particle uniformity, and may be appropriately used for an electrochemical device.

In another embodiment of the present invention, a supercapacitor including the electrode described above, an electrolyte, and a separator is provided. The supercapacitor has excellent electrostatic capacity and stability.

The supercapacitor includes the aforementioned electrode, and has the same structure as other common supercapacitors except for the electrode.

The electrolyte may include any electrolyte capable of causing an electrochemical reaction with the electrode without any particular limit. Specific examples of the electrolyte may be H₂SO₄, Na₂SO₄, (NH₄)₂SO₄, KOH, LiOH, LiClO₄, KCl, Na₂SO₄, Li₂SO₄, KOH, NaCl, and the like, manganese oxide (MnO₂, Mn₂O₃, or Mn₃O₄), nickel oxide (NiO), vanadium oxide (V₂O₅), tungsten oxide (WO₃), cobalt oxide (CoO, Co₂O₃, or Co₃O₄), molybdenum oxide (MoO₃), or a combination thereof.

The separator is a porous insulating material, and may be a film stack including polyethylene or polypropylene, or a fibrous non-woven fabric including cellulose, polyester, or polypropylene.

In another embodiment of the present invention, a rechargeable lithium battery including the above-described electrode, an electrolyte, and a separator is provided. The electrode may be a negative electrode or a positive electrode. The rechargeable lithium battery according to the present invention has excellent electrostatic capacity and stability.

The rechargeable lithium battery includes a positive electrode, a negative electrode, a separator interposed between the positive electrode and negative electrode, an electrolyte impregnated in the separator, a battery case, and a member sealing the battery case.

The negative electrode may be the electrode described above. In general, a negative electrode includes a current collector and a negative active material layer disposed on the current collector, and the negative active material layer includes a negative active material.

The negative active material may include a material that reversibly intercalates/deintercalates lithium ions, a lithium metal, a lithium metal alloy, a material being capable of doping lithium, or transition metal oxide.

The material that reversibly intercalates/deintercalates lithium ions is a carbon material. In a lithium ion rechargeable battery, any generally-used carbon-based negative active material may be used. Examples thereof may be crystalline carbon, amorphous carbon, or a combination thereof. Examples of the crystalline carbon may be graphite such as shapeless, sheet-shaped, flake, spherical, or fiber-shaped natural graphite or artificial graphite, and examples of the amorphous carbon may be soft carbon (carbon fired at a low temperature) or hard carbon, a mesophase pitch carbonized product, fired coke, and the like.

The lithium metal alloy may be an alloy of lithium and a metal of Na, K, Rb, Cs, Fr, Be, Mg, Ca, Sr, Si, Sb, Pb, In, Zn, Ba, Ra, Ge, Al, or Sn.

The material being capable of doping lithium may be Si, SiOₓ (0<x<2), a Si—C composite, a Si-Q alloy (wherein Q is an alkali metal, an alkaline-earth metal, a Group 13 to 16 element, a transition element, a rare earth element, or a combination thereof, and is not Si), Sn, SnO₂, a Sn—C composite, Sn—R (wherein R is an alkali metal, an alkaline-earth metal, a Group 13 to 16 element, a transition element, a rare earth element, or a combination thereof, and is not Sn), and the like. Specific elements of the Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may be vanadium oxide, lithium vanadium oxide, and the like.

The positive electrode may be the electrode described above. In general a positive electrode includes a current collector and a positive active material layer disposed on the current collector, and the positive active material layer includes a positive active material.

The positive active material may include a compound (lithiated intercalation compound) being capable of intercalating and deintercallating lithium. The positive active material may be lithium composite oxide including at least one metal selected from cobalt, manganese, nickel, or a combination thereof, and may be the compounds represented by the following Chemical Formulae. LiₐA_{1-b}R_{b}D₂ (wherein, in the above chemical formula, 0.90≦a≦1.8 and 0≦b≦0.5); LiₐE_{1-b}R_{b}O_{2-c}D_{c} (wherein, in the above chemical formula, 0.90≦a≦1.8, 0≦b≦0.5, and 0≦c≦0.05); LiE_{2-b}R_{b}O_{4-c}D_{c} (wherein, in the above chemical formula, 0≦b≦0.5 and 0≦c≦0.05); LiₐNi_{1-b-c}Co_{b}R_{c}D_{α} (wherein, in the above chemical formula, 0.90≦a≦1.8, 0≦b≦0.5, 0≦c≦0.05, and 0<α≦2); LiₐNi_{1-b-c}Co_{b}R_{c}O_{2-α}Z_{α} (wherein, in the above chemical formula, 0.90≦a≦1.8, 0≦b≦0.5, 0≦c≦0.05, and 0<α<2); LiₐNi_{1-b-c}Co_{b}R_{c}O_{2-α}Z₂ (wherein, in the above chemical formula, 0.90≦a≦1.8, 0≦b≦0.5, 0≦c≦0.05, and 0<α<2); LiₐNi_{1-b-c}Mn_{b}R_{c}D_{α} (wherein, in the above chemical formula, 0.90≦a≦1.8, 0≦b≦0.5, 0≦c≦0.05, and 0<α2); LiₐNi_{1-b-c}Mn_{b}R_{c}O_{2-α}Z_{α} (wherein, in the above chemical formula, 0.90≦a≦1.8, 0≦b≦0.5, 0≦c≦0.05, and 0<α<2); LiₐNi_{1-b-c}Mn_{b}R_{c}O_{2-α}Z₂ (wherein, in the above chemical formula, 0.90≦a≦1.8, 0≦b≦0.5, 0≦c≦0.05, and 0<α<2); LiₐNi_{b}E_{c}G_{d}O₂ (wherein, in the above chemical formula, 0.90≦a≦1.8, 0≦b≦0.9, 0≦c≦0.5, and 0.001≦d≦0.1); LiₐNi_{b}Co_{c}MnₐGeO₂ (wherein, in the above chemical formula, 0.90≦a≦1.8, 0≦b≦0.9, 0≦c≦0.5, 0≦d≦0.5, and 0.001≦e≦0.1); LiₐNiG_{b}O₂ (wherein, in the above chemical formula, 0.90≦a≦1.8 and 0.001≦b≦0.1); LiₐCoG_{b}O₂ (wherein, in the above chemical formula, 0.90≦a≦1.8 and 0.001≦b≦0.1); LiₐMnG_{b}O₂ (wherein, in the above chemical formula, 0.90≦a≦1.8 and 0.001≦b≦0.1); LiₐMn₂G_{b}O₄ (wherein, in the above chemical formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The above compounds may have a coating layer thereon, or the compounds may be mixed with a compound with a coating layer.

The negative electrode and positive electrode may further include a binder and/or a conductive material.

The electrolyte includes a non-aqueous organic solvent and a lithium salt. The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone and the like. The alcohol-based solvent may include ethanol, isopropyl alcohol, and the like. The aprotic solvent include nitriles such as R—CN (wherein R is a C2 to C20 linear, branched, or cyclic hydrocarbon group, and may include a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio may be controlled in accordance with a desirable battery performance.

The separator may include any materials commonly used in the conventional lithium battery as long as it separates a negative electrode from a positive electrode and provides a transporting passage for lithium ions. In other words, it may have low resistance to ion transport and excellent impregnation for an electrolyte. For example, it may be selected from glass fiber, polyester, TEFLON (tetrafluoroethylene), polyethylene, polypropylene, polytetrafluoroethylene (PTFE), or a combination thereof. It may have a form of a non-woven fabric or a woven fabric. For example, for the lithium ion battery, a polyolefin-based polymer separator such as polyethylene, polypropylene, or the like is mainly used. In order to ensure heat resistance or mechanical strength, a coated separator including a ceramic component or a polymer material may be used. Selectively, it may have a mono-layered or multi-layered structure.

Hereinafter, examples of the present invention and comparative examples are described. These examples, however, should not in any sense be interpreted as limiting the scope of the present invention.

### Example 1

About 1.5 to 2.0 wt % of potassium permanganate (KMnO₄, Sigma-Aldrich Co., LLC) is added to a solution prepared by dispersing 0.5 wt % of graphene oxide having an average particle diameter of 500 nm and an average thickness of 1.0 to 1.2 nm in water. The graphene oxide includes 46 wt % of carbon, 46 wt % of oxygen, 0.5 wt % of nitrogen, and 0.3 wt % of hydrogen.

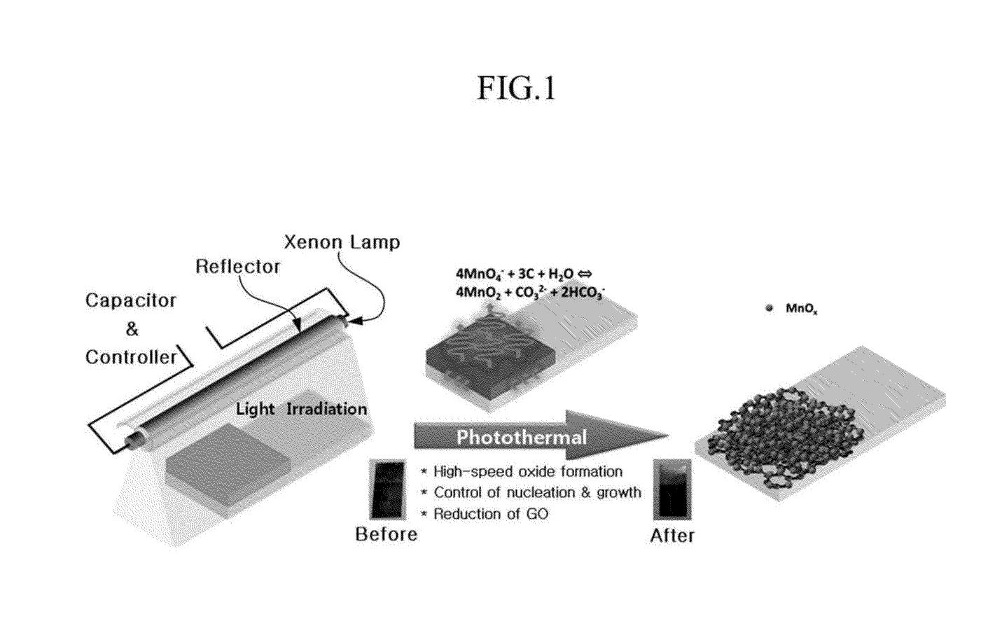

The mixture is coated on a stainless steel. The coated stainless steel is heat-treated (baked) in a 70° C. vacuum oven for 30 minutes, forming a thin film. Then, IPL is radiated on the thin film under the following conditions, fabricating an electrode. The fabrication of the electrode is illustrated in detail referring to FIG. 1.

The number of pulses: 1,

On-time: 20 ms,

Off-time: 0 ms,

Voltage: 386 V,

Total energy: 22.3 J/cm²

The electrode as a first electrode is used with Na₂SO₄ as an electrolyte solution, platinum (Pt) as a counter electrode, and Ag/AgCl as a reference electrode to fabricate a half cell.

### Example 2

A half cell was fabricated according to the same method as Example 1, except for using potassium permanganate (KMnO₄, Sigma-Aldrich Co., LLC) in an amount of 2.0 wt %, and was then tested regarding performance of an electrode used therein through an electrostatic capacity measurement experiment.

### Experimental Example 1

### Scanning Electron Microscope

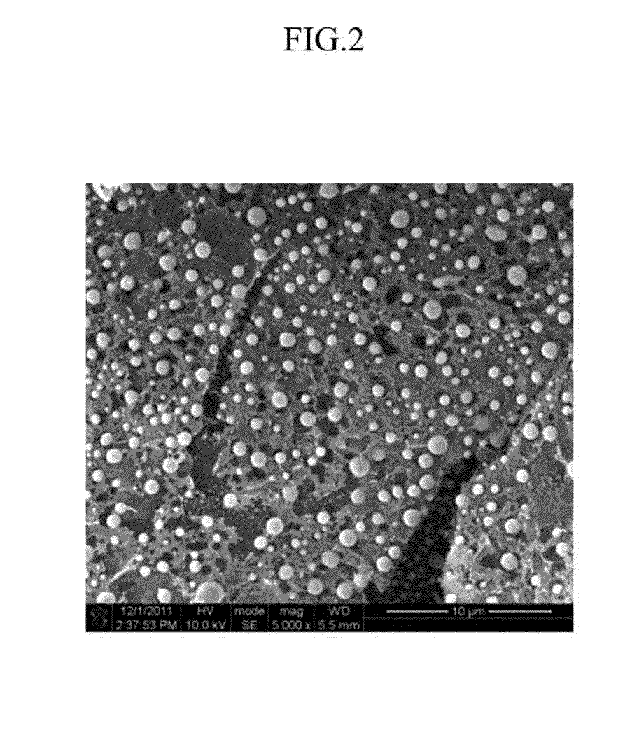

A scanning electron microscope (SEM) photograph of the electrode according to Example 1 is provided in FIG. 2. Referring to FIG. 2, grapheme and manganese oxide (MnO₂) were uniformly dispersed on a current collector.

### Experimental Example 2

### X-Ray Diffraction (XRD) Evaluation

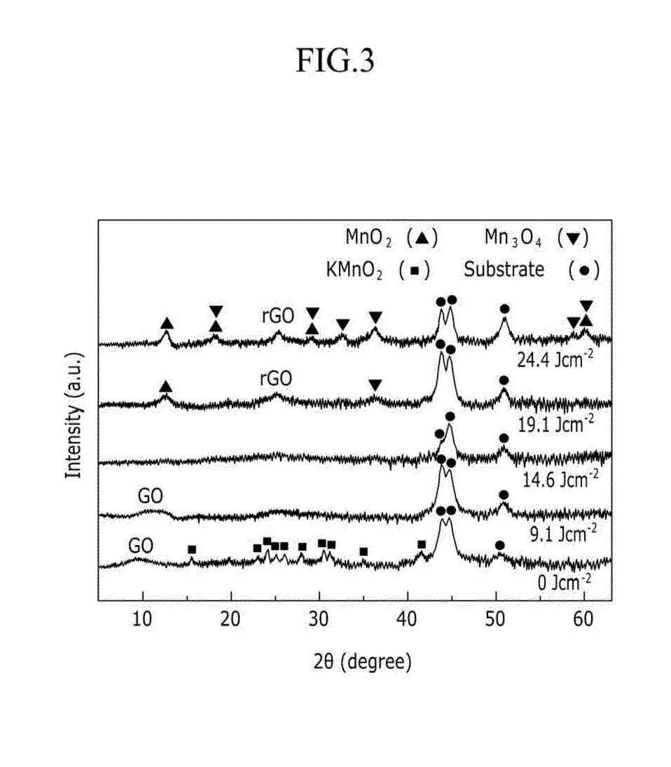

The X-ray diffraction pattern of the electrode according to Example 1 is provided in FIG. 3. Referring to FIG. 3, most of graphene oxide was reduced. Since the peak of the graphene oxide around 10-15° disappeared after IPL treatment, the reduction of graphene oxide was verified.

### Experimental Example 3

### Electrochemical Characteristic Evaluation

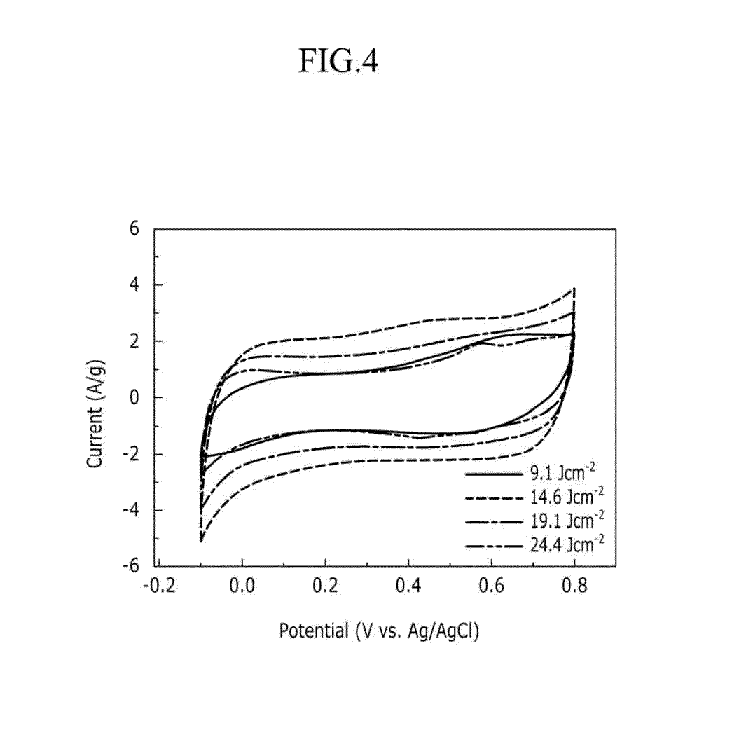

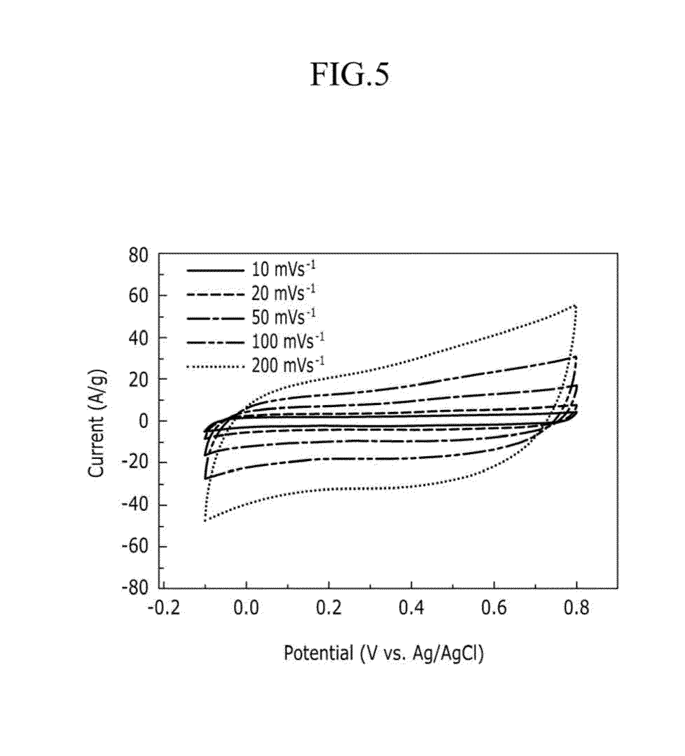

A thin film supercapacitor including the electrode according to Example 1 was measured regarding a circulating current to evaluate the electrochemical characteristics. FIG. 4 shows curves of circulating current measurements at a scanning rate of 10 mV/s when graphene oxide was respectively treated with different IPL energies. FIG. 5 shows curves of circulating current measurements at different scanning rates when the IPL energy was 14.6 J/cm².

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for an electrode, comprising:
mixing at least two electrode materials selected from a carbon material, a metal oxide precursor, and a conductive polymer with a solvent to prepare a mixture;
coating the mixture on a current collector; and
radiating IPL (intense pulsed light) on the mixture coated on the current collector.

2. The method of claim 1, wherein the carbon material is activated carbon, graphite, graphene, graphene oxide, carbon nanotubes, or a combination thereof.

3. The method of claim 1, wherein the electrode material comprises a carbon material,
the carbon material is graphene oxide, and
the graphene oxide is reduced by radiating the IPL.

4. The method of claim 1, wherein the metal oxide precursor is an oxide precursor of a metal including copper, nickel, ruthenium, manganese, molybdenum, vanadium, aluminum silver, iridium, iron, cobalt, chromium, tungsten, titanium, palladium, or a combination thereof.

5. The method of claim 1, wherein the conductive polymer comprises a polyaniline-based polymer, a polythiophene-based polymer, a polypyrrole-based polymer, a polyacetylene-based polymer, a polyparaphenylene-based polymer, or a combination thereof.

6. The method of claim 1, wherein the electrode material is a carbon material and a metal oxide precursor.

7. The method of claim 6, wherein the carbon material and metal oxide precursor are mixed in a weight ratio of 1:0.1 to 1:10.

8. The method of claim 1, wherein the electrode material is a carbon material and a conductive polymer.

9. The method of claim 1, wherein the electrode material is a metal oxide precursor and a conductive polymer.

10. The method of claim 1, which further comprises removal of a solvent after coating the mixture on a current collector.

11. The method of claim 1, wherein the IPL radiation is conducted at room temperature.

12. The method of claim 1, wherein the IPL radiation is conducted under an air atmosphere.

13. The method of claim 1, wherein the IPL has a pulse on-time ranging from 0.1 to 500 ms, a pulse off-time ranging from 0.1 to 500 ms, a number of pulses ranging from 1 to 99, or pulse energy ranging from 0.1 to 200 J/cm².

14. An electrode manufactured according to the method of claim 1 and comprising at least two kinds of electrode material selected from a carbon material, a metal oxide precursor, and a conductive polymer that are uniformly dispersed on a current collector.

15. A supercapacitor comprising the electrode of claim 14, an electrolyte, and a separator.

16. A rechargeable lithium battery comprising the electrode of claim 14, an electrolyte, and a separator.
